(19) United States
(12) Patent Application Publication
(10) Pub. No.: US 2024/0192793 A1
(43) Pub. Date: Jun. 13, 2024

(54) METHODS AND SYSTEMS FOR POCKET MODE DETECTION

(71) Applicant: STMicroelectronics International N.V., Geneva (CH)

(72) Inventors: Hyeok LIM, Incheon (KR); Kyeong Min OH, Siheung-si (KR); Ji Won PARK, Seoul (KR)

(21) Appl. No.: 18/062,638

(22) Filed: Dec. 7, 2022

(51) Int. Cl. G06F 3/041

(52) U.S. Cl. CPC G06F 3/0416

(57) ABSTRACT

A method for operating an electronic device includes a touchscreen controller of the electronic device measuring a first plurality of touch strengths at a first plurality of touch nodes located within a first region of a touch sensing panel of the electronic device coupled to the touchscreen controller, and the touchscreen controller determining whether the electronic device is in a pocket mode based on the first plurality of touch strengths.

### TECHNICAL FIELD

The present invention relates generally to systems and methods for operating a touchscreen, and in particular embodiments to systems and methods for pocket mode detection.

### BACKGROUND

Electronic devices that are designed for user interaction have historically utilized external input devices such as keyboards, key pads, and mice to capture user input. In recent years, there has been a push from the more traditional methods, as consumers prefer the convenience of portable devices that can support a more flexible lifestyle. To this end, there has been a rise in smaller, portable, hand-held electronic devices, such as mobile phones, tablets, gaming systems, smart watches, and any other wearable electronic devices, etc. This has given rise to the popularity of touchscreens and touch panel displays as systems for capturing user input. Not only do they provide the functionality of the traditional electronic devices, but touchscreens provide additional features. For example, given the appropriate software, users are able to utilize touchscreens for sketching, drawing, and various hand writing applications.

Unintentional touches may occur to an electronic device with a touchscreen and may cause an undesired operation and an unpleasant user experience if not handled properly. For example, a mobile device may dial out a phone call without its user realizing the dialing due to an accidental touch made by the user. The unintentional or accidental touches often happen when the electronic device is in a dark place such as a pocket or a bag. The user may not intend to operate the electronic device and thus put the electronic device in the pocket or the bag. However, the undesired operations may occur when the touchscreen of the electronic device comes into contact with various objects either inside or outside of the pocket. For instance, a capacitive touchscreen may touch a conductive object in the pocket and recognize such a touch. In another example, if the electronic device is located in a pocket attached to clothes of the user, the capacitive touchscreen may make a contact with the body of the user even though there is a piece of cloth between the capacitive touchscreen and the body. To prevent mis-operations on the touchscreen, the electronic device may enable a feature called “pocket mode” to determine that it is located in the pocket or the bag and take appropriate actions.

Conventional pocket mode detection may use a proximity sensor or an illuminance sensor to determine whether the electronic device is in a dark environment. When the proximity sensor detects a close object or the illuminance sensor determines that the light intensity is low, the electronic device may enable the pocket mode and pop-up a user interface (UI) on its screen to block accidental touches. The UI may lock the screen temporarily until a timer expires or the user completes a specific touch gesture following the instruction on the lock screen. In the pocket mode, the electronic device may even disable some touchscreen functionalities such as the double-tapping or the finger print scanning. However, the conventional pocket mode detection methods may not be accurate because the proximity and illuminance sensors are merely effective for detecting objects in their nearby areas and cannot sense the entire screen. Therefore, techniques to improve the performance of the pocket mode detection are desired.

### SUMMARY

In accordance with an embodiment, a method for operating an electronic device includes a touchscreen controller of the electronic device measuring a first plurality of touch strengths at a first plurality of touch nodes. The first plurality of touch nodes is located within a first region of a touch sensing panel of the electronic device. The touch sensing panel is coupled to the touchscreen controller. The method further includes the touchscreen controller determining whether the electronic device is in a pocket mode based on the first plurality of touch strengths.

In accordance with another embodiment, a touchscreen controller coupled to a touch sensing panel of an electronic device includes a processor and a memory for storing a program to be executed by the processor. The program includes instructions when executed cause the touchscreen controller to measure a first plurality of touch strengths at a first plurality of touch nodes and determine whether the electronic device is in a pocket mode based on the first plurality of touch strengths. The first plurality of touch nodes is located within a first region of the touch sensing panel.

In accordance with yet another embodiment, an electronic device includes a touch sensing panel and a touchscreen controller coupled together. The touch sensing panel includes a plurality of transmitting (TX) touch sensors and a plurality of receiving (RX) touch sensors. The touchscreen controller includes a processor and a memory for storing a program to be executed by the processor. The program includes instructions when executed cause the touchscreen controller to measure a first plurality of touch strengths at a first plurality of touch nodes and determine whether the electronic device is in a pocket mode based on the first plurality of touch strengths. The first plurality of touch nodes is located within a first region of the touch sensing panel. Each of the first plurality of touch node is determined by one of the plurality of TX touch sensors and one of the plurality of RX touch sensors.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A illustrates a stack-up diagram of a conventional display;

FIG. 1B is a block diagram of an electronic device according to some embodiments;

FIG. 1C illustrates a schematic of a touch sensing panel;

FIGS. 2A-2C illustrate exemplary electronic readouts of touch strengths caused by intentional touches and accidental touches;

FIG. 3 illustrates a flow chart of a pocket mode detection algorithm according to some embodiments;

FIG. 4 illustrates a flow chart of the pocket mode detection algorithm according to some other embodiments;

FIG. 5 illustrates a flow chart performed by an application processor (AP) of an electronic device according to some embodiments;

FIGS. 6A-6C illustrate a method performed by a touchscreen controller of an electronic device according to some embodiments.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments. The references used herein are provided merely for convenience and hence do not define the extent of protection or the scope of the embodiments.

Embodiments of the present application relate to determining whether an electronic device is in a pocket mode based on touch strengths measured at a touch sensing panel of the electronic device, rather than relying upon a proximity sensor or an illuminance sensor. In an embodiment, a method for operating an electronic device includes a touchscreen controller of the electronic device measuring a plurality of touch strengths at a plurality of touch nodes. The plurality of touch nodes is located within a region of a touch sensing panel of the electronic device. The touch sensing panel is coupled to the touchscreen controller. The method further includes the touchscreen controller determining whether the electronic device is in a pocket mode based on the plurality of touch strengths. In various embodiments, the region is located at the top of the touch sensing panel. The above aspects and other inventive aspects are discussed in greater detail below.

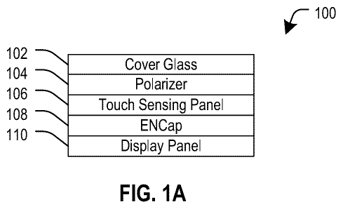

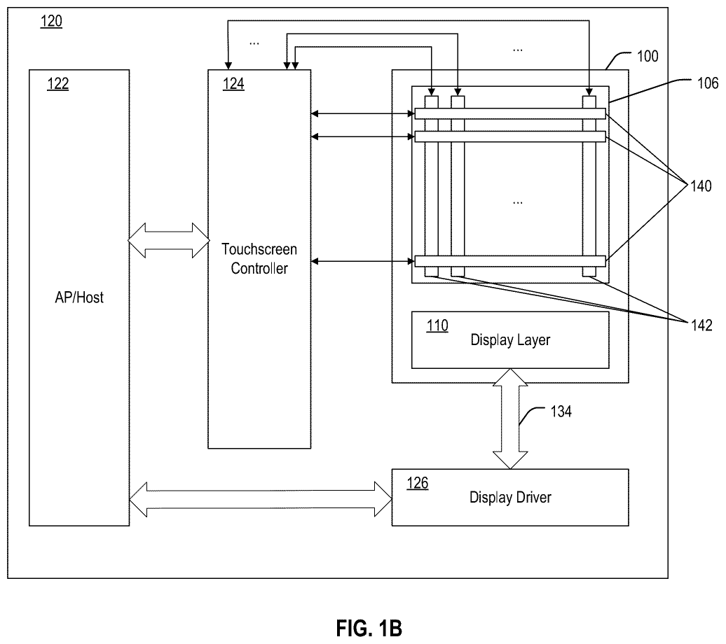

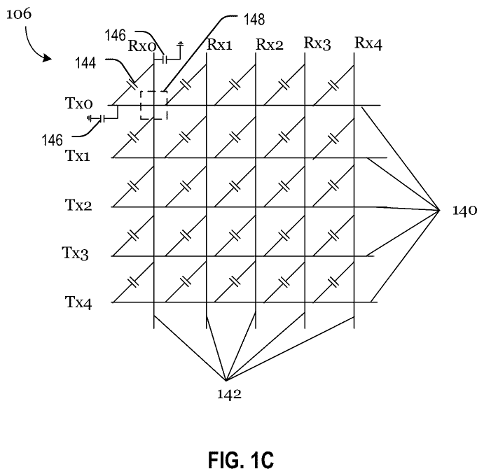

FIG. 1A illustrates a stack-up diagram of a conventional display 100. The display 100 may be an organic light emitting diode (OLED) display or any other type of display integrated with a touch sensing function. The display 100 may also be referred to as a touchscreen, a touchscreen display or a touch display. The display 100 may include a stack-up of a plurality of different layers. As a non-limiting example, the display 100 may comprise a cover glass layer 102, a polarizer film layer 104, a touch sensing panel 106, an encapsulation film layer 108, and a display panel 110. The display panel 110 may comprise a plurality of pixel elements formed across rows and columns of the display 100 in an array like formation. The pixel elements may be OLED and may be configured to transmit light having a color (such as red, green, or blue) with a brightness based on the current they are driven with. The pixel elements may also be implemented based on non-OLED techniques. The encapsulation film layer 108 may be formed in direct contact with the display panel 110. The encapsulation film 120 may function to prevent oxygen, water, or moisture from external sources reaching into and damaging the display panel 110. The touch sensing panel 106 may be a capacitive touch panel configured to detect touches made on the display 100. The touch sensing panel 106 may include a plurality of touch sensing electrodes (which may also be referred to as touch sensors). The touch sensing electrodes may be deposited and attached onto the encapsulation film 120 (e.g., in an on-cell type display). Alternatively, the touch sensing electrodes may be printed or fabricated with the encapsulation film 120 (e.g., in an in-cell type display). The polarizer film layer 104 may be used for controlling the characteristics of the display 100 such as external light reflection, color accuracy, luminance, and so on. The cover glass layer 102 may be a protective layer to protect the display 100. The cover glass layer 102 may comprise a transparent material such as a thin layer of glass including silicon dioxide. Additional layers known in the art may also be included in the display 100.

FIG. 1B is a block diagram of an electronic device 120 according to some embodiments. The electronic device 120 may include a display panel 100, a host 122, a touchscreen controller 124, and a display driver 126. The electronic device 120 may be a smart phone, a Global Positioning System (GPS) device, a tablet computer, a mobile media player, a laptop, a gaming system, a personal computer, or any other electronic device that may utilize a touchscreen display (such as the display panel 100).

The host 122, also referred to as a system on a chip or an application processor (AP), comprises a processor, interface, circuitry, and the like configured to direct the flow of input and output data to the touchscreen controller 124 and the display driver 126. For example, the host 122 may be the CPU of a smartphone. A memory may be coupled to or otherwise integrated with the host 122. The memory may be programmed for short term and/or long term memory storage. The memory may comprise various programs to be executed in the host 122. The memory may include both volatile and non-volatile memories. The host 122 may be configured to, e.g., transmit image data, updated display refresh rates, and/or synchronization signals to the display driver 126 and to receive touch related signals such as coordinates or touch control signals from the touchscreen controller 124.

The display panel 100 may include a touch sensing panel 106 and a display layer 110. The display layer 110 is configured to display an image in accordance with display signals 134 and synchronization signals (including a VSYNC signal and an HSYNC signal not shown in FIG. 1B) received from the display driver 126. The display driver 126 may perform various methods with respect to the display panel 100. In various embodiments, the display driver 126 may be a processor that analyzes information and carries out a series of executable scripts, e.g., stored in a memory integrated in the display driver 126. Alternatively, the display driver 126 and the touchscreen controller 124 may share a common memory. In one or more embodiments, the processor may comprise an application-specific integrated circuit (ASIC) device, a central processing unit (CPU), or any other processing unit known in the art. In various embodiments, the display driver 126 may refresh an image displayed on the display panel 100 based on a display refresh rate and/or synchronization signals received from the host 122. Optionally, the display driver 126 may transmit the VSYNC signal and the HSYNC signal to the touchscreen controller 124.

The touch sensing panel 106 in the display panel 100 is configured to detect touches made on the display panel 100. The touch sensing panel 106 may include transmitting (TX) touch sensors 140 and receiving (RX) touch sensors 142. The TX touch sensors may also be referred to as TX electrodes or TX channels. The RX touch sensors may also be referred to as RX electrodes or RX channels. The TX touch sensors 140 and RX touch sensors 142 may span the entirety of the display panel 100 or the touch sensing panel 106 in a grid-like fashion that are operable by the touchscreen controller 124. In various embodiments, the TX touch sensors 140 may be formed in rows across the touch sensing panel 106 and the RX touch sensors 142 may be formed in columns across the touch sensing panel 106. In other embodiments, the RX touch sensors 142 may be formed in rows across the touch sensing panel 106 and the TX touch sensors 140 may be formed in columns across the touch sensing panel 106. The TX touch sensors 140 and the RX touch sensors 142 may overlap in certain embodiments. While FIG. 1B depicts the TX touch sensors 140 and the RX touch sensors 142 overlapping in an orthogonal manner, they may overlap other than orthogonally such as being interleaved or at various angles.

The touchscreen controller 124 may perform various methods with respect to the display panel 100. In various embodiments, the touchscreen controller 124 may be a processor that analyzes information and carries out a series of executable scripts, e.g., stored in a memory integrated in the touchscreen controller 124. For example, the memory may include non-volatile memory (such as read-only memory (ROM) or Flash) and random access memory (RAM). The memory integrated in the touchscreen controller 124 may store firmware that is determined in accordance with the series of executable scripts. In one or more embodiments, the processor may comprise an application-specific integrated circuit (ASIC) device, a central processing unit (CPU), or any other processing unit known in the art. In various embodiments, the touchscreen controller 124 may comprise a number of separate computing units such as cores integrated within one processor, or distinct separate processing chips.

FIG. 1C illustrates a schematic of the touch sensing panel 106. The touch sensing panel 106 may comprise TX touch sensors 140 (Tx0-Tx4) and RX touch sensors 142 (Rx0-Rx4) that span the entirety of the display panel 100 in a grid-like fashion that are operable by the touchscreen controller 124. The TX touch sensors 140 may also be referred to as drive lines, and the RX touch sensors 142 may also be referred to as sense lines. The TX touch sensors Tx0-Tx4 and RX touch sensors Rx0-Rx4 may be coupled to the touchscreen controller 124. Although five TX touch sensors and five RX touch sensors are illustrated in FIG. 1C, this is not indicative of the number of touch sensors that may be present on the touch sensing panel 106. Any suitable number of TX and RX touch sensors may be used in the touch sensing panel 106.

The TX touch sensors 140 and the RX touch sensors 142 may have a measurable mutual capacitance at their intersections 148 as to form a matrix of mutual capacitors with mutual capacitances 144. As appreciated by those with ordinary skill in the art, each of the TX touch sensors 140 and the RX touch sensors 142 may also have a self-capacitance 146 that is measurable. In other words, the TX touch sensors 140 and the RX touch sensors 142 are operable in mutual sensing mode and a self-sensing mode.

In one or more embodiments, the mutual sensing process includes the touchscreen controller 124 selecting and driving a particular row of the TX touch sensors 140 with a voltage and scanning every column of the RX touch sensors 142. In this manner, the change in the mutual capacitance 144 at each intersection 148 between a respective TX touch sensor 140 and RX touch sensor 142 is measured, resulting in mutual sensing raw data. Each of the intersections 148 may be referred to as a touch node or a touch pixel. This process is repeated sequentially for TX touch sensor 140 to determine the rest of the mutual sensing raw data. Then, after determining each value of the mutual sensing raw data, each value of the mutual sensing raw data may be subtracted from a corresponding baseline strength, resulting in touch strengths measured at each touch node 148.

In other words, during the mutual sensing scan when a row of the TX touch sensors 140 are driven, electric fields form between adjacent electrodes of the TX touch sensors 140 and the respective intersecting columns of the RX touch sensors 142. When capacitive objects such as human fingers or a stylus, touch a touch node 148 on the touch sensing panel 106, the electric field lines going through the air between adjacent lines is replaced to pass through the capacitive objects. These interruptions in the electric fields cause a detectable change in the mutual capacitance that can be quantified as mutual sensing raw data and may be converted into touch strengths by subtracting them from a corresponding baseline strength.

In various embodiments of the present disclosure, whether an electronic device is in a pocket mode is determined by distinguishing an intentional touch from an accidental touch using a touch sensing panel of the electronic device. Both the intentional touch and the accidental touch may generate touch strengths measured by the touch sensing panel. The touch strengths of the intentional touch may exhibit a pattern different from the touch strengths of the accidental touch. For the intentional touch, the object that makes contact with the touchscreen is often a human finger or a stylus that has a high conductivity, and the contact area may be small due to precision of the intentional touch. The accidental touch may be caused by an object with a low conductivity, or an object whose conductivity is reduced by some cloth located between the object and the touchscreen. And the contact area of the accidental touch may be larger. Furthermore, the intentional touch may occur anywhere on the touchscreen, but the accidental touch may occur in some specific regions more often depending on the position in which the electronic device is stored in the pocket or the bag. For example, lots of people like to put a cellphone in their trouser pocket upside down with the phone screen facing the leg. This way, their leg may get into contact with the top region of the phone screen more easily, and thus cause accidental touches.

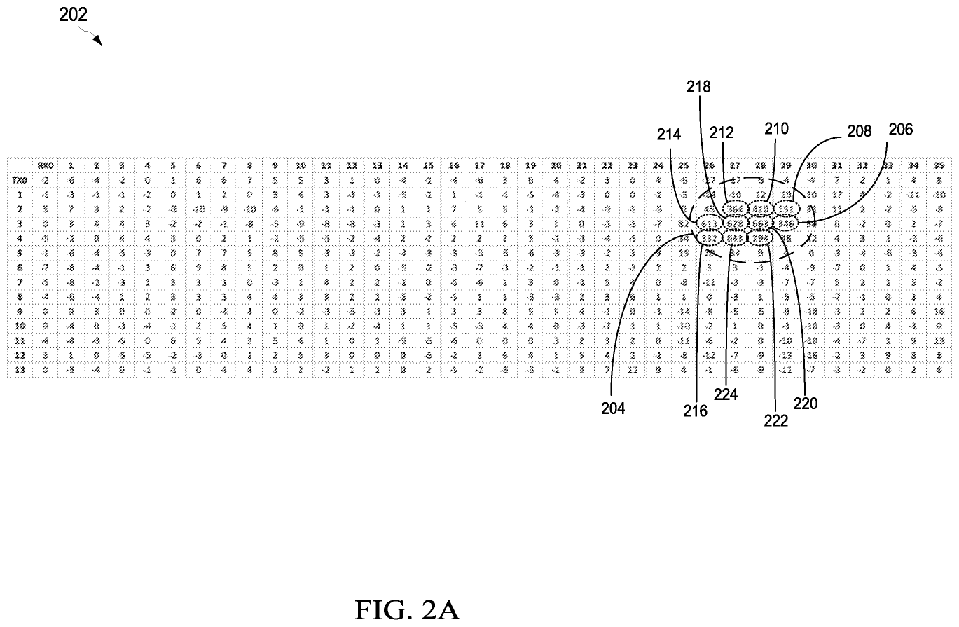

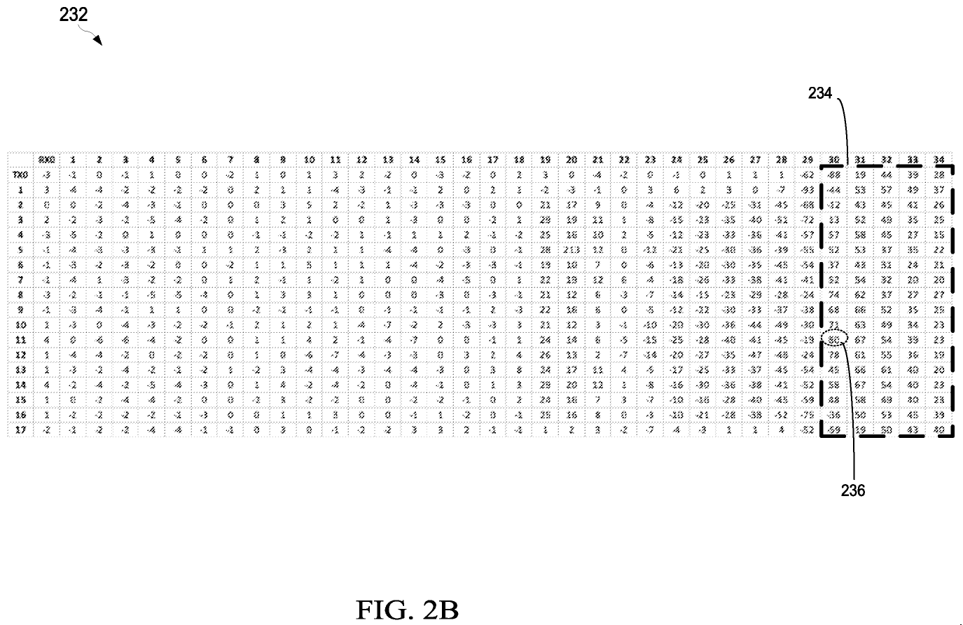

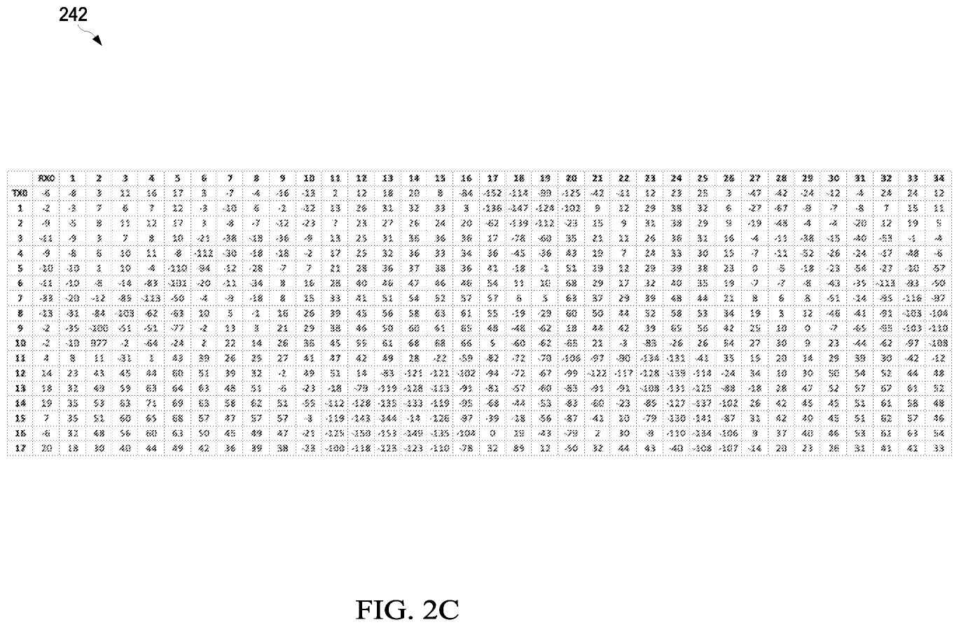

FIG. 2A illustrates an exemplary electronic readout of touch strengths 202 caused by an intentional touch. The intentional touch makes contact with a small region 204, which is located close to TX touch sensors 2, 3, and 4 and RX touch sensors 26, 27, 28, and 29. As a result, touch strengths measured at touch nodes 206-224 are significantly larger than those measured at the other touch nodes. The maximum value of the touch strengths measured at touch nodes 206-224 is also relatively high (663 at touch node 220) because the object that causes the intentional touch has a high conductivity.

By contrast, FIG. 2B illustrates an exemplary electronic readout of touch strengths 232 caused by an accidental touch. Most of the touch strengths measured at touch nodes within a region 234 at the top of the touch sensing panel are higher than those measured at the other touch nodes. The region 234 in FIG. 2B is much larger than the region 204 in FIG. 2A and includes the touch nodes determined by TX touch sensors 30, 31, 32, 33, and 34 and RX touch sensors 0-17. However, the object that causes the accidental touch may has a lower conductivity or does not make a direct contact with the touch screen. Thus, the maximum value of the touch strengths measured at the touch nodes within the region 234 is 80 (measured at touch node 236), which is much smaller than the maximum value of the touch strengths in FIG. 2A.

Thus, when a touchscreen controller of the electronic device detects that the touch strengths measured at the touch sensing panel have a pattern similar to FIG. 2B rather than FIG. 2A, the touchscreen controller may determine that the electronic device is in the pocket mode.

Although FIG. 2B illustrates an exemplary accidental touch that occurs at the top or an upper side of the touch sensing panel, this example is not intended to be construed in a limiting sense. An accidental touch may occur at other regions of the touch sensing panel, such as the bottom, a lower side, the left side, the right side, or the middle of the touch sensing panel. Which region of the touch sensing panel triggers an unintentional touch more often may be determined by the position in which the electronic device is stored in the pocket or the bag. In another example, the entire touch sensing panel may get in contact with the conductive object due to an accidental touch. FIG. 2C illustrates an exemplary electronic readout of touch strengths 242 caused by such an accidental touch.

As shown in FIG. 2C, touch nodes that generate a higher touch strength are widely spread across the whole touch sensing panel, rather than concentrating on a specific region (as shown in FIGS. 2A and 2B). The maximum value of the touch strengths measured at the touch sensing panel in FIG. 2C is still relatively small.

The touch strengths illustrated in FIGS. 2A-2C may be determined by subtracting mutual sensing raw data from a corresponding baseline strength. Thus, some of the touch strengths may have a negative value. In various embodiments, determining the touch strengths may further include taking an absolute value of the subtraction, resulting in non-negative touch strengths.

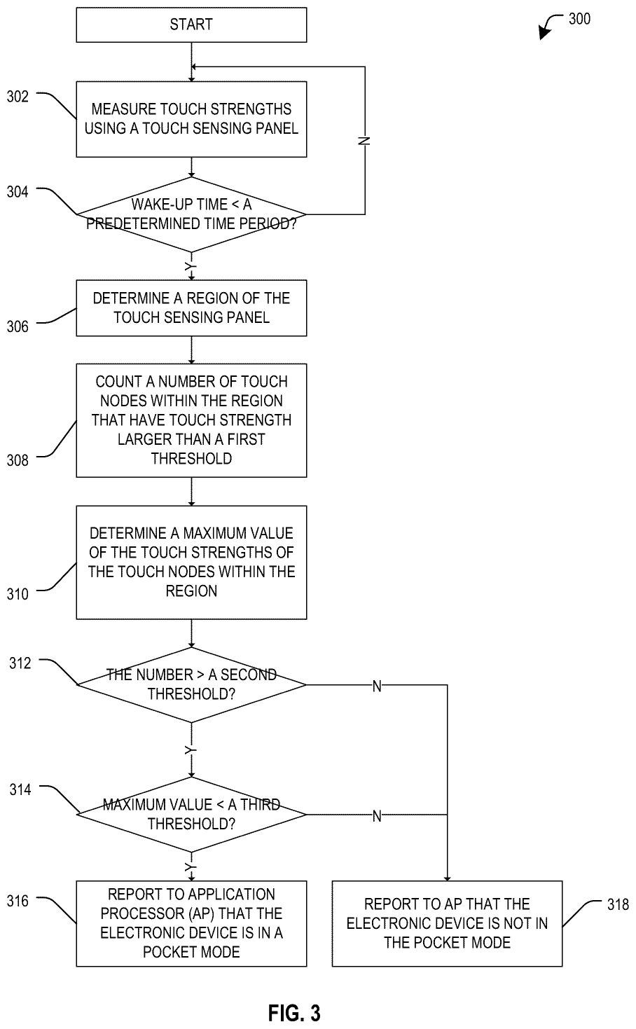

In various embodiments, a touchscreen controller of an electronic device may perform a pocket mode detection algorithm to determine whether the electronic device is in the pocket mode. FIG. 3 illustrates a flow chart 300 of the pocket mode detection algorithm according to some embodiments. The flow chart 300 begins at step 302, where the touchscreen controller measures touch strengths at touch nodes of a touch sensing panel. At step 304, the touchscreen controller may check whether a display wake-up time is shorter than a predetermined time period. If the display wake-up time is shorter than the predetermined time, the flow chart 300 proceeds to step 306. Otherwise, the flow chart 300 goes back to the start. For example, the predetermined time period may be set to 5 seconds. At step 306, the touchscreen controller may determine a region of the touch sensing panel. The region may be a rectangular area at the top or an upper side of the touch sensing panel. In one example, the region may include touch nodes at the intersections of all TX touch sensors and the first 6 RX touch sensors at the top of the touch sensing panel. In one embodiment, the region may be a fraction of the entire screen of the touch sensing panel. In various embodiments, any suitable region may be selected by the touchscreen controller in accordance with the type of the electronic device and the position in which the electronic device tends to be stored in the pocket or the bag.

At step 308, the touchscreen controller may count a number of touch nodes within the region that have touch strength larger than a first threshold. At step 310, the touchscreen controller may determine a maximum value of the touch strengths measured at the touch nodes within the region determined at step 306. At step 312, the touchscreen controller may compare the number determined at step 308 with a second threshold. At step 314, the touchscreen controller may compare the maximum value determined at step 310 with a third threshold. Only when the number is larger than the second threshold and the maximum value is smaller than the third threshold, the flow chart 300 goes to step 316, where the touchscreen controller may report to an application processor (AP) of the electronic device that the electronic device is in the pocket mode. Otherwise, the touchscreen controller may report to the AP that the electronic device is not in the pocket mode. The AP may be coupled to the touchscreen controller.

In various embodiments, at step 308, the touchscreen controller may determine a percentage which is equal to the number of touch nodes within the region that have touch strengths larger than the first threshold divided by the total number of touch nodes within the region. Accordingly, at step 312, the touchscreen controller may compare the percentage determined at step 308 with the second threshold. The first threshold, the second threshold, and the third threshold used in the flow chart 300 may be determined based on tests or simulations. For example, the first threshold may be 25, the second threshold may be 70%, and the third threshold may be set to a value slightly larger than a touch strength generated by a normal touch.

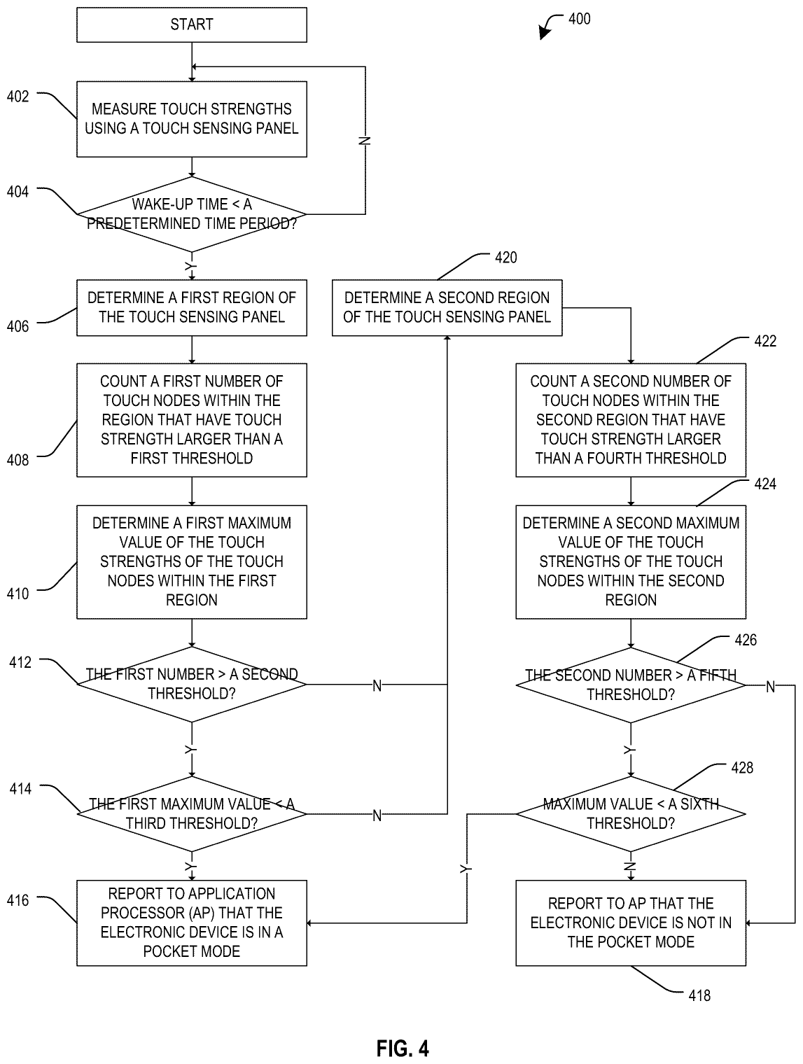

In one embodiment, after the touchscreen controller selects a region of the touch sensing panel and determines that the electronic device is not in the pocket mode based on touch strengths measured at touch nodes within the region, the touchscreen controller may select another region, and determines whether the electronic device is in the pocket mode based on touch strengths measured at touch nodes within the other region. FIG. 4 illustrates a flow chart 400 of the pocket mode detection algorithm according to such an embodiment.

The flow chart 400 begins at step 402, where the touchscreen controller measures touch strengths at touch nodes of a touch sensing panel. At step 404, the touchscreen controller may check whether a display wake-up time is shorter than a predetermined time period. If the display wake-up time is shorter than the predetermined time, the flow chart 400 proceeds to step 406. Otherwise, the flow chart 400 goes back to the start. For example, the predetermined time period may be set to 5 seconds. At step 406, the touchscreen controller may determine a first region of the touch sensing panel. The first region may be a rectangular area at the top or an upper side of the touch sensing panel. In one example, the first region may include touch nodes at the intersections of all TX touch sensors and the first 6 RX touch sensors at the top of the touch sensing panel. In various embodiments, any suitable region may be selected by the touchscreen controller in accordance with the type of the electronic device and the position in which the electronic device tends to be stored in the pocket or the bag.

At step 408, the touchscreen controller may count a first number of touch nodes within the first region that have touch strength larger than a first threshold. The touchscreen controller may further determine a first percentage being equal to the first number divided by a total number of touch nodes within the first region. At step 410, the touchscreen controller may determine a first maximum value of the touch strengths measured at the touch nodes within the first region determined at step 406. At step 412, the touchscreen controller may compare the first number or the first percentage determined at step 408 with a second threshold. At step 414, the touchscreen controller may compare the first maximum value determined at step 410 with a third threshold. Only when the first number (or the first percentage) is larger than the second threshold and the first maximum value is smaller than the third threshold, the flow chart 400 goes to step 416, where the touchscreen controller may report to an AP of the electronic device that the electronic device is in the pocket mode. Otherwise, if either the first number (or the first percentage) is smaller than the second threshold, or the first maximum value is larger than the third threshold, or both, the flow chart 400 proceeds to step 420.

At step 420, the touchscreen controller may determine a second region of the touch sensing panel. The second region may be an entire screen or a full-screen area of the touch sensing panel. Again, in various embodiments, any suitable second region may be selected by the touchscreen controller in accordance with the type of the electronic device and the position in which the electronic device tends to be stored in the pocket or the bag. At step 422, the touchscreen controller may count a second number of touch nodes within the second region that have touch strength larger than a fourth threshold. The touchscreen controller may further determine a second percentage being equal to the second number divided by a total number of touch nodes within the second region. At step 424, the touchscreen controller may determine a second maximum value of the touch strengths measured at the touch nodes within the second region determined at step 420. At step 426, the touchscreen controller may compare the second number or the second percentage determined at step 422 with a fifth threshold. At step 428, the touchscreen controller may compare the second maximum value determined at step 424 with a sixth threshold. Only when the second number (or the second percentage) is larger than the fifth threshold and the second maximum value is smaller than the sixth threshold, the flow chart 400 goes to step 416, where the touchscreen controller may report to the AP that the electronic device is in the pocket mode. Otherwise, if either the second number (or the second percentage) is smaller than the fifth threshold, or the second maximum value is larger than the sixth threshold, or both, the flow chart 400 proceeds to step 418, where the touchscreen controller may report to the AP that the electronic device is not in the pocket mode.

In various embodiments, the first, the second, the third, the fourth, the fifth, and the sixth thresholds used in the flow chart 400 may be determined based on tests or simulations. For example, the first threshold may be 25, the second threshold may be 70%, the fourth threshold may be 30, the fifth threshold may be 25%, and the third and sixth thresholds may be set to a value slightly larger than a touch strength generated by a normal touch.

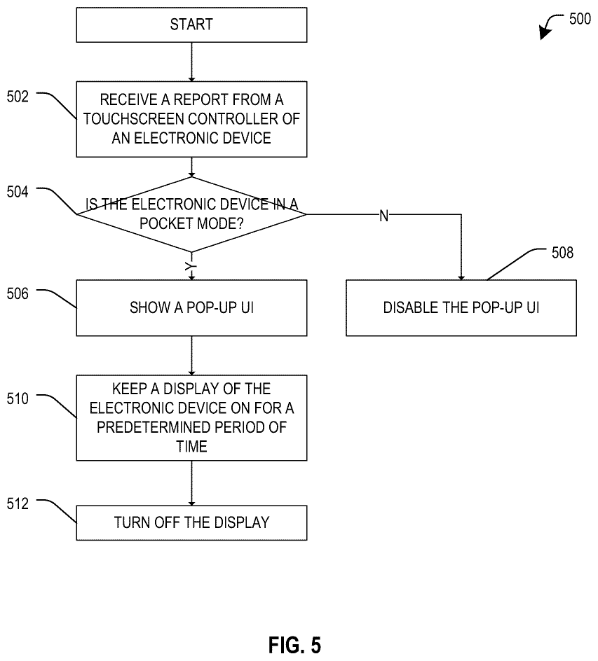

FIG. 5 illustrates a flow chart 500 performed by an AP of an electronic device according to some embodiments. The flow chart 500 begins at step 502, where an AP of an electronic device receives a report from a touchscreen controller of the electronic device. The touchscreen controller may be coupled to the AP. The report may indicate whether the electronic device is in a pocket mode. At step 504, if the report indicates that the electronic device is in the pocket mode, the flow chart 500 goes to step 506; otherwise, the flow chart 500 goes to step 508. At step 506, the AP may trigger the electronic device to show a pop-up UI on a display of the electronic device to block accidental touches. The pop-up UI may lock the screen temporarily until a timer expires or the user completes a specific touch gesture following the instruction on the lock screen. At step 508, the AP may trigger the electronic device to disable the pop-up UI. The flow chart 500 proceeds from step 506 to step 510, where the AP may keep the display of the electronic device on for a predetermined period of time. For example, the predetermined period of time may be set to 5 seconds. Then the flow chart 500 proceeds to step 512, where the AP may turn off the display.

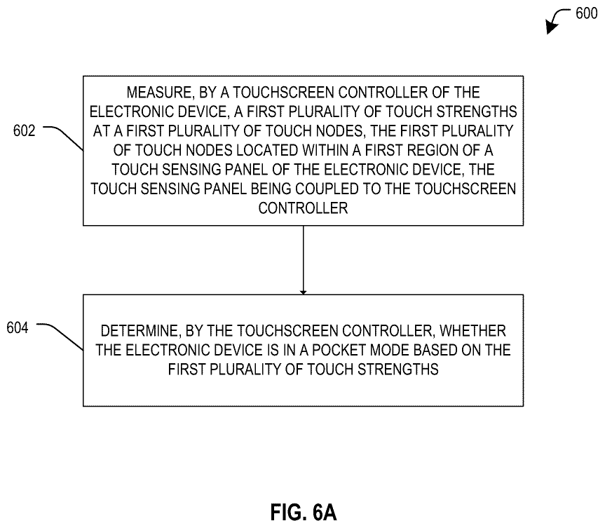

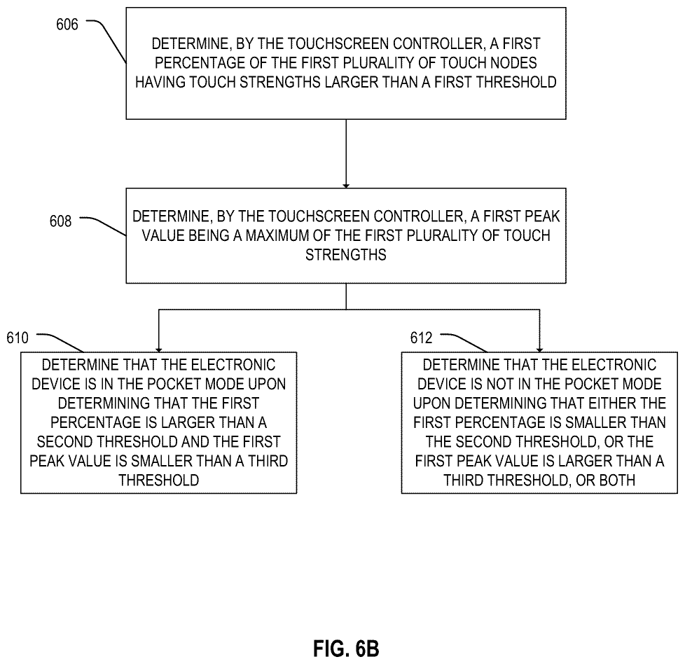

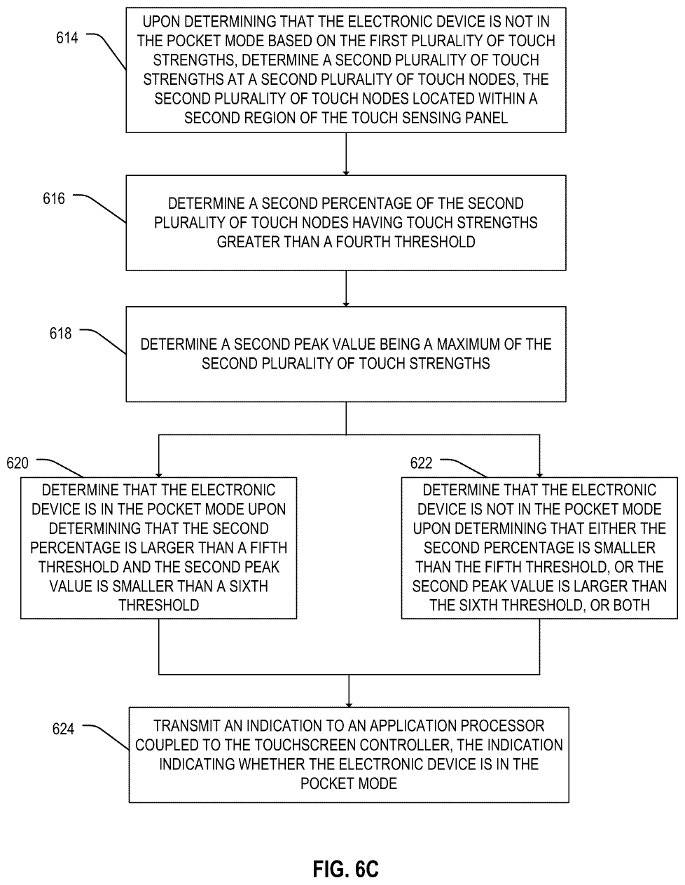

FIGS. 6A-6C illustrate a method 600 performed by a touchscreen controller of an electronic device according to some embodiments. As shown in FIG. 6A, the method 600 includes two steps 602 and 604. At step 602, the touchscreen controller measures a first plurality of touch strengths at a first plurality of touch nodes. The first plurality of touch nodes may be located within a first region of a touch sensing panel of the electronic device. The touch sensing panel may be coupled to the touchscreen controller. At step 604, the touchscreen controller determines whether the electronic device is in a pocket mode based on the first plurality of touch strengths. The electronic device may be considered to be in the pocket mode when the electronic device is located inside a pocket or a bag.

Optionally, the method 600 may further include steps 606-612 as shown in FIG. 6B. At step 606, the touchscreen controller may determine a first percentage of the first plurality of touch nodes having touch strengths larger than a first threshold. At step 608, the touchscreen controller may determine a first peak value being a maximum of the first plurality of touch strengths. At step 610, the touchscreen controller determines that the electronic device is in the pocket mode upon determining that the first percentage is larger than a second threshold and the first peak value is smaller than a third threshold. Otherwise at step 612, the touchscreen controller may determine that the electronic device is not in the pocket mode upon determining that either the first percentage is smaller than the second threshold, or the first peak value is larger than a third threshold, or both.

Optionally, the method 600 may further include steps 614-624 as shown in FIG. 6C. At step 614, the touchscreen controller may determine a second plurality of touch strengths at a second plurality of touch nodes upon determining that the electronic device is not in the pocket mode based on the first plurality of touch strengths. The second plurality of touch nodes may be located within a second region of the touch sensing panel. At step 616, the touchscreen controller may determine a second percentage of the second plurality of touch nodes having touch strengths larger than a fourth threshold. At step 618, the touchscreen controller may determine a second peak value being a maximum of the second plurality of touch strengths. At step 620, the touchscreen controller determines that the electronic device is in the pocket mode upon determining that the second percentage is larger than a fifth threshold and the second peak value is smaller than a sixth threshold. Otherwise at step 622, the touchscreen controller may determine that the electronic device is not in the pocket mode upon determining that either the second percentage is smaller than the fifth threshold, or the second peak value is larger than the sixth threshold, or both. At step 624, the touchscreen controller may transmit an indication to an AP coupled to the touchscreen controller. The indication may indicate whether the electronic device is in the pocket mode.

In various embodiments, the pocket mode detection may use both a touch sensing panel and an ambient sensor. The touchscreen controller may determine whether the electronic device is in the pocket mode based on touch strengths measured at a touch sensing panel of the electronic device and measurements generated by at least one ambient sensor. The at least one ambient sensor may include either a proximity sensor, or an illuminance sensor, or both. In one embodiment, the touchscreen controller may first preform the pocket mode detection using the measurements generated by the at least one ambient sensor. Upon determining that the electronic device is not in the pocket mode based on the measurements generated by the at least one ambient sensor, the touchscreen controller may perform the pocket mode detection methods described in FIGS. 3-6 based on the touch strengths measured at the touch sensing panel. In another embodiment, the touchscreen controller may first preform the pocket mode detection methods described in FIGS. 3-6 based on the touch strengths measured at the touch sensing panel. Upon determining that that the electronic device is not in the pocket mode based on the touch strengths measured at the touch sensing panel, the touchscreen controller may perform the pocket mode detection methods based on the measurements generated by the at least one ambient sensor. Any suitable pocket mode detection methods using the at least one ambient sensor that are known in the art may be applied here.

Example embodiments of the invention are summarized here. Other embodiments can also be understood from the entirety of the specification as well as the claims filed herein.

Example 1. A method for operating an electronic device, the method comprising measuring, by a touchscreen controller of the electronic device, a first plurality of touch strengths at a first plurality of touch nodes, the first plurality of touch nodes located within a first region of a touch sensing panel of the electronic device, the touch sensing panel being coupled to the touchscreen controller; and determining, by the touchscreen controller, whether the electronic device is in a pocket mode based on the first plurality of touch strengths.

Example 2. The method of Example 1, wherein the first region is a fraction of a full screen of the touch sensing panel.

Example 3. The methods of Example 1 and Example 2, further comprising: determining, by the touchscreen controller, a first percentage of the first plurality of touch nodes having touch strengths larger than a first threshold; and determining, by the touchscreen controller, a first peak value being a maximum of the first plurality of touch strengths, and wherein the touchscreen controller determines that the electronic device is in the pocket mode upon determining that the first percentage is larger than a second threshold and the first peak value is smaller than a third threshold.

Example 4. The methods of Example 1 through Example 3, wherein the touchscreen controller determines that the electronic device is not in the pocket mode upon determining that either the first percentage is smaller than the second threshold, or the first peak value is larger than a third threshold, or both.

Example 5. The methods of Example 1 through Example 4, further comprising: upon determining that the electronic device is not in the pocket mode based on the first plurality of touch strengths, determining a second plurality of touch strengths at a second plurality of touch nodes, the second plurality of touch nodes located within a second region of the touch sensing panel; and determining whether the electronic device is in the pocket mode based on the second plurality of touch strengths.

Example 6. The methods of Example 1 through Example 5, further comprising: determining a second percentage of the second plurality of touch nodes having touch strengths larger than a fourth threshold; and determining a second peak value being a maximum of the second plurality of touch strengths, and wherein the touchscreen controller determines that the electronic device is in the pocket mode upon determining that the second percentage is larger than a fifth threshold and the second peak value is smaller than a sixth threshold.

Example 7. The methods of Example 1 through Example 6, wherein the second region is larger than the first region.

Example 8. The methods of Example 1 through Example 7, wherein the first region is located at the top of the touch sensing panel, and wherein the second region is a full screen of the touch sensing panel.

Example 9. The methods of Example 1 through Example 8, wherein the touch sensing panel includes a plurality of TX touch sensors and a plurality of RX touch sensors, and wherein each of the first plurality of touch nodes is determined by one of the plurality of TX touch sensors and one of the plurality of RX touch sensors.

Example 10. The methods of Example 1 through Example 9, wherein each of the first plurality of touch strengths measured at a corresponding touch node is determined in accordance with a mutual capacitance between a TX touch sensor and a RX touch sensor associated with the corresponding touch node.

Example 11. The methods of Example 1 through Example 10, further comprising: transmitting, by the touchscreen controller, an indication to an application processor coupled to the touchscreen controller, the indication indicating whether the electronic device is in the pocket mode.

Example 12. The methods of Example 1 through Example 11, wherein the electronic device is in the pocket mode when the electronic device is located inside a pocket or a bag.

Example 13. The methods of Example 1 through Example 12, wherein the touchscreen controller determines whether the electronic device is in the pocket mode based on the first plurality of touch strengths and measurements generated by at least one ambient sensor of the electronic device, the at least one ambient sensor being either a proximity sensor or a light sensor.

Example 14. The methods of Example 1 through Example 13, wherein upon determining that the electronic device is not in the pocket mode based on the measurements generated by the at least one ambient sensor, the touchscreen controller determines whether the electronic device is in the pocket mode based on the first plurality of touch strengths.

Example 15. The methods of Example 1 through Example 14, wherein upon determining that the electronic device is not in the pocket mode based on the first plurality of touch strengths, the touchscreen controller determines whether the electronic device is in the pocket mode based on the measurements generated by the at least one ambient sensor.

Example 16. A touchscreen controller coupled to a touch sensing panel of an electronic device, the touch controller comprising: a processor; and a memory for storing a program to be executed by the processor, the program comprising instructions when executed cause the touchscreen controller to: measure a first plurality of touch strengths at a first plurality of touch nodes, the first plurality of touch nodes located within a first region of the touch sensing panel; and determine whether the electronic device is in a pocket mode based on the first plurality of touch strengths.

Example 17. The touchscreen controller of Example 16, wherein the first region is a fraction of a full screen of the touch sensing panel.

Example 18. The touchscreen controllers of Example 16 and Example 17, wherein the program further comprises instructions when executed cause the touchscreen controller to: determine a first percentage of the first plurality of touch nodes having touch strengths larger than a first threshold; and determine a first peak value being a maximum of the first plurality of touch strengths, and wherein the touchscreen controller determines that the electronic device is in the pocket mode upon determining that the first percentage is larger than a second threshold and the first peak value is smaller than a third threshold.

Example 19. The touchscreen controllers of Example 16 through Example 18, wherein the touchscreen controller determines that the electronic device is not in the pocket mode upon determining that either the first percentage is smaller than the second threshold, or the first peak value is larger than a third threshold, or both.

Example 20. The touchscreen controllers of Example 16 through Example 19, wherein the program further comprises instructions when executed cause the touchscreen controller to: upon determining that the electronic device is not in the pocket mode based on the first plurality of touch strengths, determine a second plurality of touch strengths at a second plurality of touch nodes, the second plurality of touch nodes located within a second region of the touch sensing panel; and determine whether the electronic device is in the pocket mode based on the second plurality of touch strengths.

Example 21. The touchscreen controllers of Example 16 through Example 20, wherein the program further comprises instructions when executed cause the touchscreen controller to: determine a second percentage of the second plurality of touch nodes having touch strengths larger than a fourth threshold; and determine a second peak value being a maximum of the second plurality of touch strengths, and wherein the touchscreen controller determines that the electronic device is in the pocket mode upon determining that the second percentage is larger than a fifth threshold and the second peak value is smaller than a sixth threshold.

Example 22. The touchscreen controllers of Example 16 through Example 21, wherein the second region is larger than the first region.

Example 23. The touchscreen controllers of Example 16 through Example 22, wherein the first region is located at the top of the touch sensing panel, and wherein the second region is a full screen of the touch sensing panel.

Example 24. The touchscreen controllers of Example 16 through Example 23, wherein the touch sensing panel includes a plurality of TX touch sensors and a plurality of RX touch sensors, and wherein each of the first plurality of touch nodes is determined by one of the plurality of TX touch sensors and one of the plurality of RX touch sensors.

Example 25. The touchscreen controllers of Example 16 through Example 24, wherein each of the first plurality of touch strengths measured at a corresponding touch node is determined in accordance with a mutual capacitance between a TX touch sensor and a RX touch sensor associated with the corresponding touch node.

Example 26. The touchscreen controllers of Example 16 through Example 25, wherein the program further comprises instructions when executed cause the touchscreen controller to: transmit an indication to an application processor coupled to the touchscreen controller, the indication indicating whether the electronic device is in the pocket mode.

Example 27. The touchscreen controllers of Example 16 through Example 26, wherein the electronic device is in the pocket mode when the electronic device is located inside a pocket or a bag.

Example 28. The touchscreen controllers of Example 16 through Example 27, wherein the touchscreen controller determines whether the electronic device is in the pocket mode based on the first plurality of touch strengths and measurements generated by at least one ambient sensor of the electronic device, the at least one ambient sensor being either a proximity sensor or a light sensor.

Example 29. The touchscreen controllers of Example 16 through Example 28, wherein upon determining that the electronic device is not in the pocket mode based on the measurements generated by the at least one ambient sensor, the touchscreen controller determines whether the electronic device is in the pocket mode based on the first plurality of touch strengths.

Example 30. The touchscreen controllers of Example 16 through Example 29, wherein upon determining that the electronic device is not in the pocket mode based on the first plurality of touch strengths, the touchscreen controller determines whether the electronic device is in the pocket mode based on the measurements generated by the at least one ambient sensor.

Example 31. An electronic device comprising: a touch sensing panel including a plurality of TX touch sensors and a plurality of RX touch sensors, and a touchscreen controller coupled to the touch sensing panel, the touchscreen controller including: a processor; and a memory for storing a program to be executed by the processor, the program comprising instructions when executed cause the touchscreen controller to: measure a first plurality of touch strengths at a first plurality of touch nodes, the first plurality of touch nodes located within a first region of the touch sensing panel, each of the first plurality of touch node determined by one of the plurality of TX touch sensors and one of the plurality of RX touch sensors; and determine whether the electronic device is in a pocket mode based on the first plurality of touch strengths.

Example 32. The electronic device of Example 31, further including an application processor coupled to the touchscreen controller, wherein the program further comprises instructions when executed cause the touchscreen controller to: transmit an indication to the application processor, the indication indicating whether the electronic device is in the pocket mode.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for operating an electronic device, the method comprising:
measuring, by a touchscreen controller of the electronic device, a first plurality of touch strengths at a first plurality of touch nodes, the first plurality of touch nodes located within a first region of a touch sensing panel of the electronic device, the touch sensing panel being coupled to the touchscreen controller; and
determining, by the touchscreen controller, whether the electronic device is in a pocket mode based on the first plurality of touch strengths.

2. The method of claim 1, wherein the first region is a fraction of a full screen of the touch sensing panel.

3. The method of claim 1, further comprising:
determining, by the touchscreen controller, a first percentage of the first plurality of touch nodes having touch strengths larger than a first threshold; and
determining, by the touchscreen controller, a first peak value being a maximum of the first plurality of touch strengths, and wherein the touchscreen controller determines that the electronic device is in the pocket mode upon determining that the first percentage is larger than a second threshold and the first peak value is smaller than a third threshold.

4. The method of claim 3, wherein the touchscreen controller determines that the electronic device is not in the pocket mode upon determining that either the first percentage is smaller than the second threshold, or the first peak value is larger than a third threshold, or both.

5. The method of claim 1, further comprising:
upon determining that the electronic device is not in the pocket mode based on the first plurality of touch strengths, determining a second plurality of touch strengths at a second plurality of touch nodes, the second plurality of touch nodes located within a second region of the touch sensing panel; and
determining whether the electronic device is in the pocket mode based on the second plurality of touch strengths.

6. The method of claim 5, further comprising:
determining a second percentage of the second plurality of touch nodes having touch strengths larger than a fourth threshold; and
determining a second peak value being a maximum of the second plurality of touch strengths, and wherein the touchscreen controller determines that the electronic device is in the pocket mode upon determining that the second percentage is larger than a fifth threshold and the second peak value is smaller than a sixth threshold.

7. The method of claim 5, wherein the first region is located at the top of the touch sensing panel, and wherein the second region is a full screen of the touch sensing panel.

8. The method of claim 1, wherein the touch sensing panel includes a plurality of transmitting (TX) touch sensors and a plurality of receiving (RX) touch sensors, and wherein each of the first plurality of touch nodes is determined by one of the plurality of TX touch sensors and one of the plurality of RX touch sensors.

9. The method of claim 1, wherein each of the first plurality of touch strengths measured at a corresponding touch node is determined in accordance with a mutual capacitance between a TX touch sensor and a RX touch sensor associated with the corresponding touch node.

10. The method of claim 1, further comprising:
transmitting, by the touchscreen controller, an indication to an application processor coupled to the touchscreen controller, the indication indicating whether the electronic device is in the pocket mode.

11. The method of claim 1, wherein the touchscreen controller determines whether the electronic device is in the pocket mode based on the first plurality of touch strengths and measurements generated by at least one ambient sensor of the electronic device, the at least one ambient sensor being either a proximity sensor or a light sensor, and wherein upon determining that the electronic device is not in the pocket mode based on the measurements generated by the at least one ambient sensor, the touchscreen controller determines whether the electronic device is in the pocket mode based on the first plurality of touch strengths.

12. A touchscreen controller coupled to a touch sensing panel of an electronic device, the touchscreen controller comprising:
a processor; and
a memory for storing a program to be executed by the processor, the program comprising instructions when executed cause the touchscreen controller to:
measure a first plurality of touch strengths at a first plurality of touch nodes, the first plurality of touch nodes located within a first region of the touch sensing panel; and
determine whether the electronic device is in a pocket mode based on the first plurality of touch strengths.

13. The touchscreen controller of claim 12, wherein the first region is a fraction of a full screen of the touch sensing panel.

14. The touchscreen controller of claim 12, wherein the program further comprises instructions when executed cause the touchscreen controller to:
determine a first percentage of the first plurality of touch nodes having touch strengths larger than a first threshold; and
determine a first peak value being a maximum of the first plurality of touch strengths, and wherein the touchscreen controller determines that the electronic device is in the pocket mode upon determining that the first percentage is larger than a second threshold and the first peak value is smaller than a third threshold.

15. The touchscreen controller of claim 14, wherein the touchscreen controller determines that the electronic device is not in the pocket mode upon determining that either the first percentage is smaller than the second threshold, or the first peak value is larger than a third threshold, or both.

16. The touchscreen controller of claim 12, wherein the program further comprises instructions when executed cause the touchscreen controller to:
upon determining that the electronic device is not in the pocket mode based on the first plurality of touch strengths, determine a second plurality of touch strengths at a second plurality of touch nodes, the second plurality of touch nodes located within a second region of the touch sensing panel; and
determine whether the electronic device is in the pocket mode based on the second plurality of touch strengths.

17. The touchscreen controller of claim 16, wherein the program further comprises instructions when executed cause the touchscreen controller to:
determine a second percentage of the second plurality of touch nodes having touch strengths larger than a fourth threshold; and
determine a second peak value being a maximum of the second plurality of touch strengths, and wherein the touchscreen controller determines that the electronic device is in the pocket mode upon determining that the second percentage is larger than a fifth threshold and the second peak value is smaller than a sixth threshold.

18. The touchscreen controller of claim 16, wherein the first region is located at the top of the touch sensing panel, and wherein the second region is a full screen of the touch sensing panel.

19. The touchscreen controller of claim 12, wherein the touch sensing panel includes a plurality of transmitting (TX) touch sensors and a plurality of receiving (RX) touch sensors, and wherein each of the first plurality of touch nodes is determined by one of the plurality of TX touch sensors and one of the plurality of RX touch sensors.

20. The touchscreen controller of claim 12, wherein each of the first plurality of touch strengths measured at a corresponding touch node is determined in accordance with a mutual capacitance between a TX touch sensor and a RX touch sensor associated with the corresponding touch node.

21. The touchscreen controller of claim 12, wherein the program further comprises instructions when executed cause the touchscreen controller to:
transmit an indication to an application processor coupled to the touchscreen controller, the indication indicating whether the electronic device is in the pocket mode.

22. The touchscreen controller of claim 12, wherein the touchscreen controller determines whether the electronic device is in the pocket mode based on the first plurality of touch strengths and measurements generated by at least one ambient sensor of the electronic device, the at least one ambient sensor being either a proximity sensor or a light sensor, and wherein upon determining that the electronic device is not in the pocket mode based on the measurements generated by the at least one ambient sensor, the touchscreen controller determines whether the electronic device is in the pocket mode based on the first plurality of touch strengths.

23. An electronic device comprising:
a touch sensing panel including a plurality of transmitting (TX) touch sensors and a plurality of receiving (RX) touch sensors, and
a touchscreen controller coupled to the touch sensing panel, the touchscreen controller including:
a processor; and
a memory for storing a program to be executed by the processor, the program comprising instructions when executed cause the touchscreen controller to:
measure a first plurality of touch strengths at a first plurality of touch nodes, the first plurality of touch nodes located within a first region of the touch sensing panel, each of the first plurality of touch node determined by one of the plurality of TX touch sensors and one of the plurality of RX touch sensors; and
determine whether the electronic device is in a pocket mode based on the first plurality of touch strengths.

24. The electronic device of claim 23, further including an application processor coupled to the touchscreen controller, wherein the program further comprises instructions when executed cause the touchscreen controller to:
transmit an indication to the application processor, the indication indicating whether the electronic device is in the pocket mode.
